(19) United States
(12) Patent Application Publication
(10) Pub. No.: US 2021/0088931 A1
(43) Pub. Date: Mar. 25, 2021

(54) PRINTING SUBSTANCE CONCENTRATION CONTROL

(71) Applicant: Hewlett-Packard Development Company, L.P., Spring, TX (US)

(72) Inventors: Shachar Berger, Ness Ziona (IL); Lital Mesika, Ness Ziona (IL); Alon Froom, Ness Ziona (IL)

(73) Assignee: Hewlett-Packard Development Company, L.P., Spring, TX (US)

(21) Appl. No.: 16/771,711

(22) PCT Filed: Jan. 25, 2018
(86) PCT No.: PCT/US2018/015199

§ 371 Date: Jun. 11, 2020

(51) Int. Cl. G03G 15/08

(52) U.S. Cl. CPC G03G 15/0851

(57) ABSTRACT

An example method of controlling the concentration of a printing substance is provided. A layer of printing substance is received on a printing substance receiving member, and a parameter indicative of a current concentration of non-volatile material in the printing substance is measured. The current concentration is compared to a predetermined target concentration. Based on the comparison, a concentration adjustment is determined. The adjustment comprises at least one of (i) an adjustment to a pressure applied to the printing substance receiving member by a pressurizing member, and (ii) an adjustment to a voltage applied to the pressurizing member. The concentration of the printing substance is controlled based on the determination.

### BACKGROUND

Electrophotographic printing refers to a process of printing in which a printing substance (e.g., a liquid or dry electrophotographic ink or toner) can be applied onto a surface having a pattern of electrostatic charge. The printing substance conforms to the electrostatic charge to form an image in the printing substance that corresponds to the electrostatic charge pattern. In liquid electrophotographic (LEP) printing, the printing substance has non-volatile material, for example in the form of toner particles, and a carrier fluid. Devices that employ LEP technology can be used to increase the concentration of non-volatile material within a printing substance, in order to supply a relatively highly concentrated printing substance for use in LEP printing presses.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram showing a concentration adjustment apparatus to control the concentration of a printing substance, in accordance with an example;

FIGS. 2a-2c show examples of measurement profiles that can be used to adjust the concentration of a printing substance by a controller of the example concentration adjustment apparatus of FIG. 1;

FIG. 3 is a flow diagram showing an example method of controlling the concentration of a printing substance;

FIG. 4 is a non-transitory computer readable storage medium comprising a set of computer-readable instructions to be carried out by a processor, according to an example; and

FIG. 5 is a flow diagram showing a further example method of controlling the concentration of a printing substance.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In some electrophotographic printers, a printing substance may be transferred onto a photo imaging member by one or more Binary Ink Developer (BID) units. In some examples, the printing substance may be liquid ink. In other examples the printing substance may be other than liquid ink, such as toner. In some examples, there may be one BID unit for each printing substance and/or printing substance color. During printing, the appropriate BID unit can be engaged with the photo imaging member. The engaged BID unit may present a uniform film of printing substance to the photo imaging member.

The printing substance may comprise electrically charged pigment particles that are attracted to oppositely-charged electrical fields on the image areas of the photo imaging member. The printing substance may be repelled from the charged, non-image areas. The result may be that the photo imaging member is provided with the image, in the form of an appropriate pattern of the printing substance, on its surface. In other examples, such as those for black and white (monochromatic) printing, one or more BID units may alternatively be provided.

Particles of a printing substance may be referred to generally as ink particles (including particles in a liquid ink). The ink may be a liquid toner, comprising non-volatile material (e.g. ink particles) and a carrier liquid. The carrier liquid may be an imaging oil. An example liquid toner ink is HP Electrolnk™. In this case, pigment particles are incorporated into a resin that is suspended in a carrier liquid, such as Isopar™. The ink particles may be electrically charged such that they move when subjected to an electric field. For example, the ink particles may be negatively charged and are therefore repelled from the negatively charged portions of photo imaging member, and are attracted to the discharged portions of the photo imaging member. The pigment is incorporated into the resin and the compounded particles are suspended in the carrier liquid. The dimensions of the pigment particles are such that the printed image does not mask the underlying texture of the print substrate, so that the finish of the print is consistent with the finish of the print substrate, rather than masking the print substrate. This enables liquid electrophotographic printing to produce finishes closer in appearance to offset lithography, in which ink is absorbed into the print substrate.

Each BID unit may receive, from an associated ink tank, a printing substance having approximately 3% non-volatile solids (NVS) within a carrier fluid. The ink cans provided to users of LEP printers, which are used to re-fill the ink tanks, comprise, for example, approximately 23% NVS. BID units may comprise one or more electrodes to provide an electric field in order to provide electric charge to the ink particles. An electric field is generated between a rotatable developer roller of the BID and the electrodes, which causes a layer of electrically charged ink to develop on the developer roller. The layer is approximately 5 microns this, and comprises approximately 20% non-volatile solids. Once the electrically charged ink has been transferred from the developer roller to the photo imaging member, the ink layer is transferred to an intermediate transfer member and then to a substrate to create a printed image.

Ink concentration adjustment apparatuses that employ LEP technology can be used to increase (or decrease) the concentration of non-volatile material within a printing substance, for example having between −30% NVS and −50% NVS, for use in LEP printing presses. A printing substance having a particular % NVS concentration may be optimal for certain printing presses; if the % NVS is too high (for example, above 37% NVS based on a desired % NVS of 35%), then ink cans to which it is provided may become blocked or clogged, and if the % NVS is too low (for example, below 33% NVS based on a desired % NVS of 35%), less printing substance is provided per ink can, which is an inefficient use of resources. The concentration of non-volatile solids within the printing substance varies depending on the uniformity of the ink layer, which is in turn dependent on the pressure (both mechanical and electrostatic) applied to the printing substance being processed.

As a concentration adjustment apparatus processes ink over time, minor adjustments in the mechanical components within the apparatus, or in the ink layer thickness, may cause non-uniformity in the pressure across a printing substance receiving member on which the ink is being concentrated. This non-uniformity in the pressure applied to the ink layer causes non-uniformity in the % NVS across the surface of the receiving member, for example from the front to the rear of a rotating cylindrical drum. Additionally, changes in electrostatic pressure can cause the conductivity of the ink particles to change, which may, in turn, cause variations in the average ink layer thickness on the drum, and hence the average % NVS in the ink,

Monitoring and adjusting the concentration of a printing substance involves sampling the printing substance at various points in the concentration adjustment apparatus and transferring the samples to an offline % NVS measurement tool; such measurement can take, for example, around 15 minutes per sample. When non-uniformity in the printing substance concentration is detected, manual adjustment to the device components may be appropriate, and further sampling and offline measurement should then be performed to determine whether the adjustment has had the desired effect. Therefore, obtaining, and maintaining, a printing substance having a desired concentration can be an inefficient, inaccurate and time-consuming process.

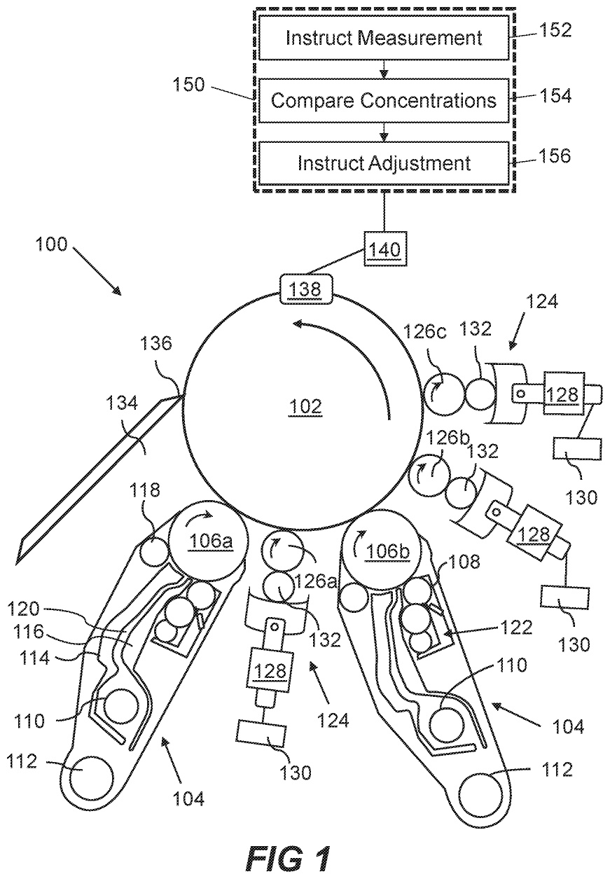

FIG. 1 shows an example of a front view of a concentration adjustment apparatus 100 to control the concentration of a printing substance. The apparatus 100 comprises a printing substance receiving member 102, which may be a rotatable cylinder, drum or continuous belt. At least one printing substance development unit 104, for example in the form of a BID unit similar to those used in LEP printers, is provided; in the example of FIG. 1, two BID units 104 are shown, but more BID units 104 may be provided. Each printing BID unit 104 can engage with the receiving member 102 to transfer a layer of printing substance onto a surface of the receiving member 102 via a developer roller 106a, 106b (referred to generally herein as developer roller 106). After the transfer of printing substance to the receiving member 102, a cleaner roller 108 removes residual printing substance from the developer roller 106. At least one voltage source (not shown) can be provided to each BID unit, and these can be controlled by one or more controllers. In an example, each component of the BID unit 104 that uses a voltage supply, such as the developer roller 106, the cleaner roller 108 and a developer electrode 114, 116, has its own associated power supply.

The BID unit 104 may comprise, for example, an ink inlet 110, an ink outlet 112, a developer electrode (having a main electrode 114 and a back electrode 116) and a squeezer roller 118. In use, the BID unit 104 may receive ink from an ink tank (not pictured) through an inlet 110. The ink supplied to the BID unit 104 (also referred to as undeveloped ink) may comprise about 3% non-volatile solids (NVS) by volume, such as about 3% ink particles by volume. The ink tank may be arranged separately from the BID unit 104 in the concentration adjustment apparatus 100, and may be connected to the inlet 110 by a conduit (not pictured). The ink supplied to the BID unit 104 may travel from the ink inlet 110 through a channel 120 in the developer electrode, which may cause some of the ink particles to become charged. The entire ink flow reaches the top of the channel 120, and approximately 80% of the ink flow then continues to flow the developer roller 106 and the main electrode 114, wherein some of the charged particles may be developed onto the surface of the developer roller 106. The ink disposed on the surface of the developer roller 106 may then be dispersed into a layer of more uniform thickness by the squeezer roller 118 (both mechanically and electrostatically), and then transferred to the receiving member 102. The ink disposed on the surface of the developer roller 106 (also referred to as developed ink) may comprise about 25% non-volatile solids by volume, such as about 25% ink particles by volume. The remaining 20% of the ink that reaches the top of the channel 120 flows between the receiving member 102 and the back electrode 116 to a cleaning unit 122 which includes the cleaner roller 108. The cleaning unit 122 may be arranged such that, in use, residual developed ink left on the developer roller 106 after ink has been transferred to the receiving member 102 may be transferred to the cleaning roller 108. The remaining undeveloped ink can be mixed with the residual developed ink. This is referred to as “ink remixing”, Ink which is not transferred to the developer roller 106, including any remixed ink, may flow out through the ink outlet 112 and return to the ink tank (not shown).

The example of FIG. 1 also shows three pressurizing members 124. A single pressurizing member 124 may be provided, and in an example at least one pressurizing member 124 is provided for each BID unit 104 that is present. Each pressurizing member 124 can include a pressurizing roller 126a-126c (referred to generally herein as pressurizing rollers 126), which can engage with the receiving member 102 to apply pressure to the surface of the receiving member 102, and hence to the layer of printing substance that has been transferred by the developer roller 106 of each BID unit 104. Each pressurizing roller 126 can be a rubber roller having a metal core; such rollers may be referred to as “squeegee” rollers. Each developer roller 106 and each pressurizing roller 126 may move relative to the receiving member 102 in order to transfer the layer of printing substance, and apply pressure to the receiving member 102; in the example of FIG. 1, the receiving member 102 rotates anti-clockwise, while the developer rollers 106 and pressurizing rollers 126 rotate clockwise.

The pressure applied to the receiving member 102 by the pressurizing rollers 126 may be mechanical, electrical or both of these. A positioning system can adjust a position of the pressurizing roller 126 relative to the receiving member 102, to thereby adjust the mechanical pressure applied to the layer of printing substance by the pressurizing roller 126. The positioning system may include a pneumatic engage system having, for example, a first pneumatic component 128 positioned under the pressurizing roller 126 at the front of the apparatus 100, and a second pneumatic component (not shown) positioned under the pressurizing roller 126 at the rear of the apparatus 100. By adjusting the pneumatic components individually, the inclination of the surface of each pressurizing roller 126 can be adjusted such that the pressurizing roller makes contact with, and applies a suitably even mechanical pressure across, the surface of the receiving member 102. Therefore, adjusting the positioning system can maintain a uniform thickness in the printing substance layer across the surface of the receiving member 102. In addition, for example, increasing the mechanical pressure applied to the printing substance on the surface of the receiving member 102 can squeeze a proportion of the carrier fluid from the printing substance as the receiving member 102 and the pressurizing roller 126 move, or rotate, relative to one another. This can result in an increase in the concentration of non-volatile solids (e.g. ink particles) in the printing substance remaining on the receiving member 102.

A voltage source 130 can also be provided to selectively apply a voltage to the pressurizing roller 126, for example via a metal roller 132, which may be referred to as a “balancing” roller. In an example, the receiving member 102 may be grounded. The metal roller applies an electrical bias to the pressurizing roller 126, creating a potential difference between the pressurizing roller 126 and the receiving member 102. Therefore, increasing the voltage applied to the pressurizing rollers, and hence increasing the potential difference between the pressurizing rollers 126 and the receiving member 102, increases the electrostatic pressure applied to the electrically charged printing substance; the electrically charged non-volatile solid particles are repelled towards the surface of the receiving member 102. This can also result in an increase in the concentration of non-volatile solids (e.g. ink particles) in the printing substance and in a more uniform concentration of non-volatile solids across the receiving member 102.

In the example of FIG. 1, a portion of the surface of the receiving member 102 rotates anti-clockwise from a printing substance removing member, for example in the form of a tray 134, and meets a first BID unit 104 having a first developer roller 106a, which transfers a first layer of printing substance onto the surface of the printing substance receiving member 102. This first layer is supplied by the first developer roller 106a at a concentration of approximately 20% NVS to 30% NVS, at a rate of approximately 20 kg of printing substance per hour. The first developer roller 106a of the first BID unit 104 may be supplied with a voltage of between approximately 400V to 600V, while the receiving member 102 is grounded. As the receiving member 102 continues to rotate, an initial or first pressurizing roller 126a, which is supplied with a voltage of approximately 2000V to 5000V, applies mechanical and electrostatic pressure to the first layer of printing substance, increasing the concentration of the first layer to approximately 30% NVS to 50% NVS. Next, a second BID unit 104 having a second developer roller 106b transfers a second layer of printing substance on top of the first layer of printing substance on the receiving member 102. This second layer is supplied by the second developer roller 106b at a concentration of approximately 20% NVS to 30% NVS, at a rate of approximately 15 kg per hour. The second developer roller 106b may have a supply voltage of approximately 1000V to 1500V. The voltage supplied to the second developer roller 106b may be higher than that supplied to the first developer roller 106a because the electrostatic charge of the non-volatile particles in the first layer should be overcome; the higher potential pushes the non-volatile particles towards the surface of the receiving member 102. As the receiving member 102 continues to rotate, a subsequent or second pressurizing roller 126b, which is supplied with a voltage of approximately 2000V to 5000V, applies mechanical and electrostatic pressure to the first and second layers of printing substance, helping to merge the first and second layer into a single, merged layer having a substantially uniform concentration. The second pressurizing roller 126b may increase the concentration of the merged layer to approximately 30% NVS to 50% NVS. A third pressurizing roller 126c, and further subsequent pressurizing rollers, may be provided to increase the uniformity and concentration of the layer of printing substance on the receiving member 102. In other examples, additional sets of BID units 104 and associated pressurizing members 124 may be provided to increase the volume of concentrated printing substance that is output by the apparatus 100.

As explained above, where the printing substance has non-volatile particles suspended in a carrier fluid, some of the carrier fluid may be mechanically squeezed from the printing substance by the pressurizing rollers as the receiving member 102 rotates. Therefore, the resulting, concentrated printing substance that reaches the tray 134 may be a paste that can be scraped by a blade 136 onto the tray 134, and towards a conveyor (not shown) for packing into receptacles such as ink cans. In an example, an output target for the apparatus 100 is a printing substance having approximately 35% NVS at an output rate of 35 kg per hour.

FIG. 1 also shows a sensor 138, which is provided to measure a parameter indicative of a current concentration of non-volatile material in the printing substance on the surface of the receiving member 102. The sensor 138 may be a concentration sensor. In one example, the measured parameter is moisture content; sensor 138 is a moisture content sensor, such as a near-infrared moisture sensor. In another example, the concentration of non-volatile solids can be measured directly. In an example where the receiving member 102 is a cylindrical drum, a first sensor 138 is mounted on a front side of the receiving member 102, and a second sensor (not shown) is mounted directly opposite the first sensor 138 on a rear side of the drum. Each sensor 138 may be provided with its own power supply and be connected to a controller 140, to which measurements are sent; therefore, measurements are taken in “real time” and in situ, and there is no need to remove samples of the printing substance from the surface of the receiving member 102. The two sensors 138 or controller 140 are able to determine or derive the % NVS of the printing substance from the measurements taken at two respective measurement points on the front and rear of the receiving member 102.

The controller 140, discussed in more detail below, controls part, or all, of the ink concentrating process. The controller 140 may comprise a microprocessor and a memory. For example, a memory 150 may comprise a set of computer-readable instructions stored thereon to perform functions such as those explained below. Alternatively, these functions may be implemented in dedicated circuitry. In an example, apparatus 100 can comprise electronic circuitry to receive a control signal from the microprocessor and, in response, to cause the controller 140 to adjust at least one of the pressure applied by the pressurizing member and the voltage applied to the pressurizing member.

Referring to FIG. 1, the controller 140 is provided to instruct, at instruction 152, at least one sensor 138 to measure a parameter indicative of a current concentration of non-volatile material in the printing substance. The controller 140 then compares, at instruction 154, the current concentration to a predetermined target concentration. Based on the comparison, the controller 140 then controls the concentration of the printing substance by instructing adjustment of at least one of (i) the pressure applied by the pressurizing member; and (ii) the voltage applied to the pressurizing member. By using an online tool that takes measurements in situ, the controller 140 can instruct an adjustment to the mechanical pressure applied across the receiving member, or to the electrostatic pressure applied by the pressurizing member 124, to the printing substance, in “real time”, or with very little delay compared to offline tools for measuring the % NVS. The adjustment that is determined by the controller 140 can be automatically sent as an instruction to an appropriate component of the apparatus 100, thereby minimizing any manual input, in terms of assessing the measurements and instructing or adjusting the equipment, that is employed to achieve the desired printing substance concentration.

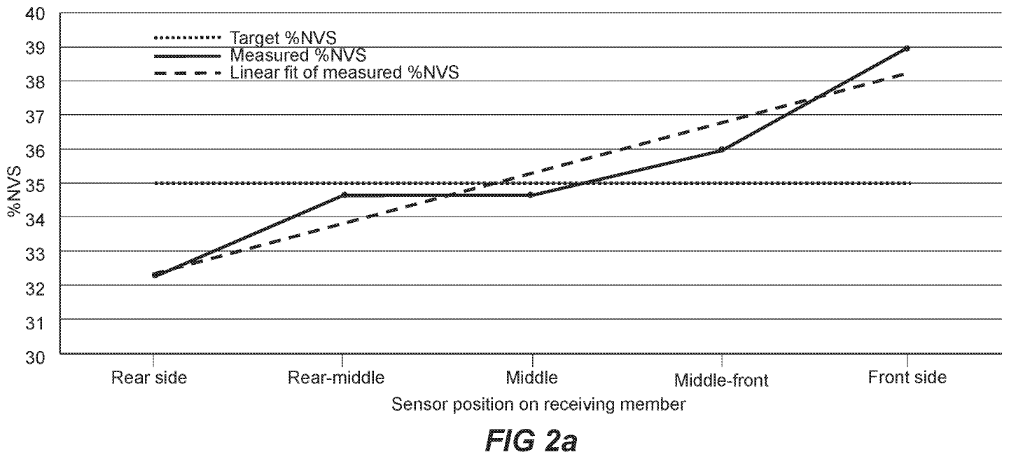

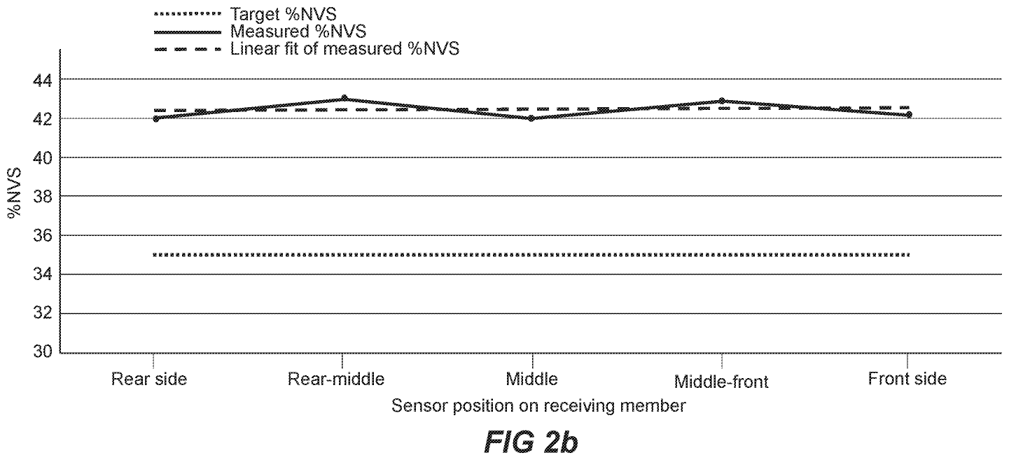

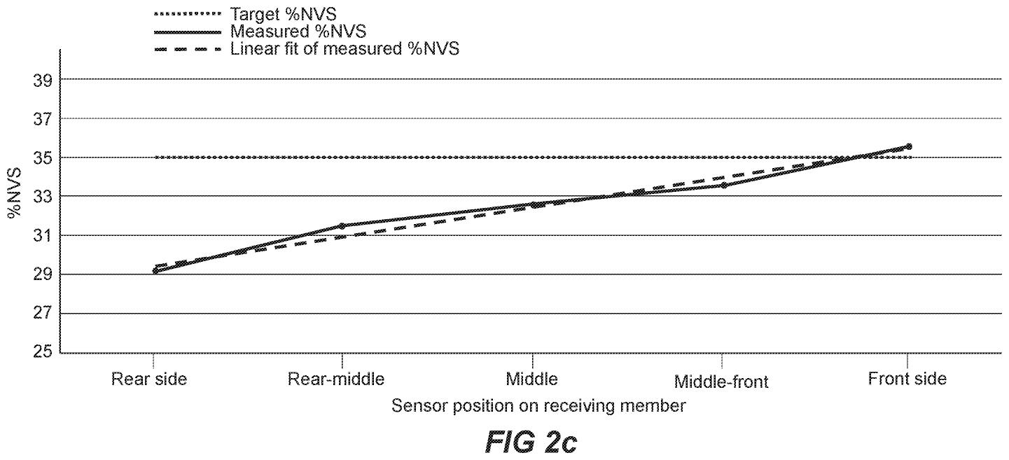

In an example, the controller 140 may be provided to compare first and second concentration measurements (or measurements of parameters indicative of first and second current concentrations) taken by the first and second measurement sensors 138, respectively, and to thereby determine an inclination of the pressurizing member relative to the surface of the printing substance receiving member. The controller 140 can then instruct the adjustment to the pressure applied by one or more of the pressurizing members 126, based on the determination made, as explained further below with reference to FIGS. 2a-2c.

FIGS. 2a-2c show examples of measurement profiles that can be used by the controller 140 to adjust the concentration of a printing substance in a concentration adjustment apparatus 100. In the example of FIG. 2a, five measurement points have been used, therefore five sensors are mounted at various points across the receiving member 102; for example, sensors may be mounted above a surface of a rotating cylindrical drum at a front side, rear side, and three equidistant points in between (labelled front-middle, middle and rear-middle, respectively). The number of measurement points can be chosen according to a number of factors, such as the availability of resources, the accuracy of the sensors used and the size of the receiving member. However, a suitably accurate indication of the inclination may be obtained with two sensors, mounted at the front side and rear side, respectively, of the receiving member. In the example, a target concentration of 35% NVS is to be achieved, with an acceptable variation of ±1% NVS; the average of the % NVS measurements is within the ±1% NVS of target range, but this is not achieved by at least the rear side and front side measurements of the % NVS. With this set of measurements, as can be envisaged by the linear fit of the measured % NVS (i.e. “average % NVS”), the controller 140 may determine that a position of the pressurizing roller 126 relative to the printing substance receiving member should be adjusted, to thereby adjust the mechanical pressure applied to the layer of printing substance by the pressurizing members. An adjustment may be made to one or more of the pressurizing rollers. In one example, an adjustment is made to each of the pressurizing rollers. In another example, an adjustment is made to the final pressurizing roller that contacts the receiving member 102 before measurements are taken by the sensors 138, i.e. pressurizing roller 126c illustrated in FIG. 1. For example, the controller 140 may determine an inclination of the pressurizing roller 126 relative to the surface of the receiving member 102 and instruct the first pneumatic component 128 (which is positioned under the pressurizing roller 126 at the front of the apparatus 100) to move in order to appropriately decrease the mechanical pressure applied to the surface of the receiving member 102, and a second pneumatic component (positioned under the pressurizing roller 126 at the rear of the apparatus 100) to move in order to appropriately decrease the mechanical pressure applied to the surface of the receiving member 102. By adjusting the pneumatic components individually in this way, the inclination of the surface of each pressurizing roller 126 can be adjusted, in real time or with little delay, such that each pressurizing roller 126 applies a suitable mechanical pressure across the surface of the receiving member 102 to produce a printing substance with a substantially uniform (e.g. ±1% NVS or ±2% NVS) concentration of non-volatile solids.

In the example of FIG. 2b, the variation between the front and rear % NVS measurements is within the acceptable variation of ±1% NVS from the target of 35% NVS; however, as can be seen by the linear fit of the measured % NVS, the average % NVS across the surface of the receiving member 102 is offset to between 42-43% NVS, above the target 35% NVS. The controller 140 may determine, based on these measurements, that a constant change in pressure is needed across the surface of the receiving member 102. This constant adjustment can be achieved by adjusting (in this case by decreasing) the DC voltage applied to the pressurizing roller 126 using the associated voltage source 130. An adjustment may be made to one or more of the pressurizing rollers. In one example, an adjustment is made to each of the pressurizing rollers. In another example, an adjustment is made to the final pressurizing roller that contacts the receiving member 102 before measurements are taken by the sensors 138, i.e. pressurizing roller 126c illustrated in FIG. 1. The controller 140 is able to assess the appropriate voltage adjustment(s) and instruct the corresponding change(s) in supply voltage automatically, thereby minimizing any manual input, in terms of assessing the measurements and instructing or adjusting the equipment, employed to achieve the desired printing substance concentration.

In the example of FIG. 2c, the linear fit of measured % NVS shows that the average measured % NVS across the receiving member 102 is below the 35% NVS target, while the gradient of this line shows that there is also non-uniformity in the % NVS of the layer of printing substance from the front to the rear of the receiving member 102. One way in which the controller may correct for the non-uniformity is to (i) instruct the first pneumatic component 128 to move in order to appropriately decrease the mechanical pressure applied to the front side surface of the receiving member 102, and a second pneumatic component to move in order to appropriately decrease the mechanical pressure applied to the rear side surface of the receiving member 102, and to also (ii) increase the DC voltage applied to the pressurizing roller 126 using the associated voltage source 130. These two adjustments may be made sequentially in any order or simultaneously, in order to achieve a printing substance with a substantially uniform (e.g. ±1% NVS) concentration of non-volatile solids.

Therefore, the adjustments may be made in “real time”, or with minimal delay, based on the real time “online” measurements taken by the sensors 138, and there is no delay owing to an offline assessment of printing substance samples.

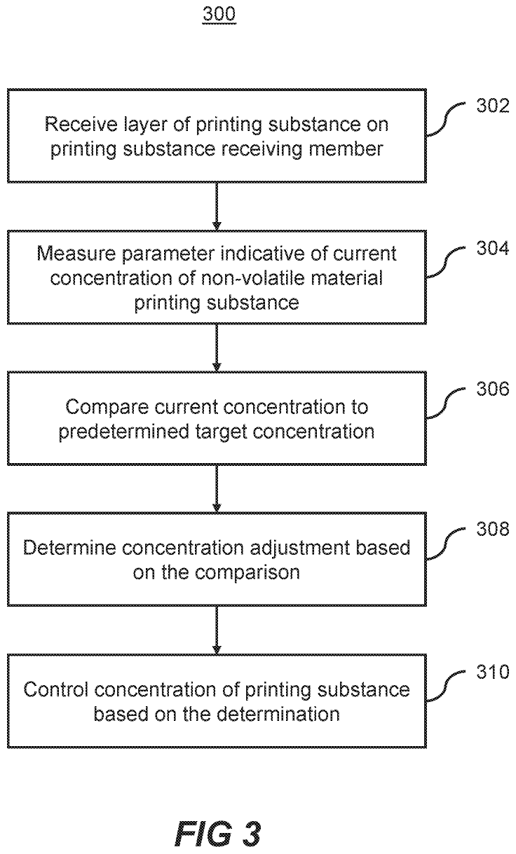

FIG. 3 is a flow diagram showing an example method 300 of controlling the concentration of a printing substance in the apparatus of FIG. 1. At block 302, a layer of printing substance is received from a BID unit 104 on the printing substance receiving member 102. At block 304, measurement of a parameter indicative of a current concentration of non-volatile material in the printing substance is made; as explained above, instruction of the measurement may be given by a controller 140 to each of two moisture sensors 138 that are positioned at the front and rear of the receiving member 102. At block 306, the current concentration is compared to a predetermined target concentration, and at block 308, based on the comparison, a concentration adjustment is determined. At block 310, the concentration of the printing substance is controlled based on the determined adjustment. The adjustment includes at least one of (i) an adjustment to a pressure applied to the printing substance receiving member by a pressurizing member, and (ii) an adjustment to a voltage applied to the pressurizing member.

In an example, the determined adjustment of blocks 308 and 310 can be considered to be a first adjustment within a continuous “closed loop” concentration control method. For example, after making the first adjustment, a parameter indicative of the adjusted concentration of non-volatile material in the printing substance can be measured as the receiving member 102 continues to rotate. The adjusted concentration can then be compared to the predetermined target concentration, which can allow the way in which the adjustment has affected the concentration of printing substance produced to be assessed in practice. Based on the comparison, a second concentration adjustment can be determined, the second adjustment again comprising at least one, and potentially both, of (i) an adjustment to the pressure applied to the printing substance receiving member by the pressurizing member, and (ii) an adjustment to the voltage applied to the pressurizing member. The concentration of the printing substance can then be controlled based on the determination of the second adjustment, and the process can be repeated as appropriate to obtain, and maintain, a suitable concentration of printing substance from the apparatus 100.

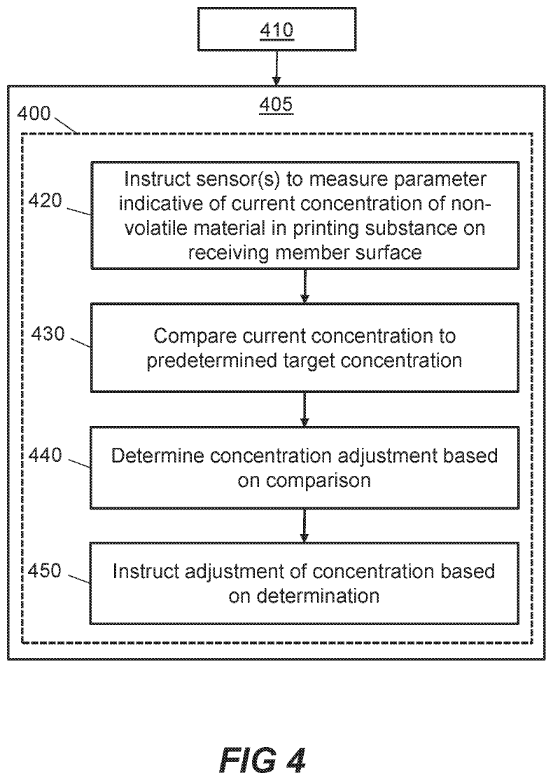

Referring to FIG. 4, an example of a non-transitory computer readable storage medium 405 may comprise a set of computer-readable instructions 400 stored thereon. The instructions are executed by a processor 410 which may form part of the controller 140 of the example apparatus 100 of FIG. 1. The instructions are executed by the processor 410 and cause it to carry out the illustrated tasks.

At block 420, the processor 410 instructs at least one sensor 138 to measure a parameter indicative of a current concentration of non-volatile material in a printing substance on the surface of a printing substance receiving member 102. At block 430, the processor 410 compares the current concentration to a predetermined target concentration. In comparing the current concentration to the predetermined target concentration, the processor 410 may determine whether the current concentration is within a predetermined concentration error margin. At block 440, the processor 410 determines a concentration adjustment based on the comparison, the adjustment comprising at least one of (i) an adjustment to a pressure applied to the printing substance receiving member by a pressurizing member 126, and (ii) an adjustment to a voltage applied to the pressurizing member 126. At block 450, the processor 410 instructs the adjustment of the concentration of the printing substance based on the adjustment determination.

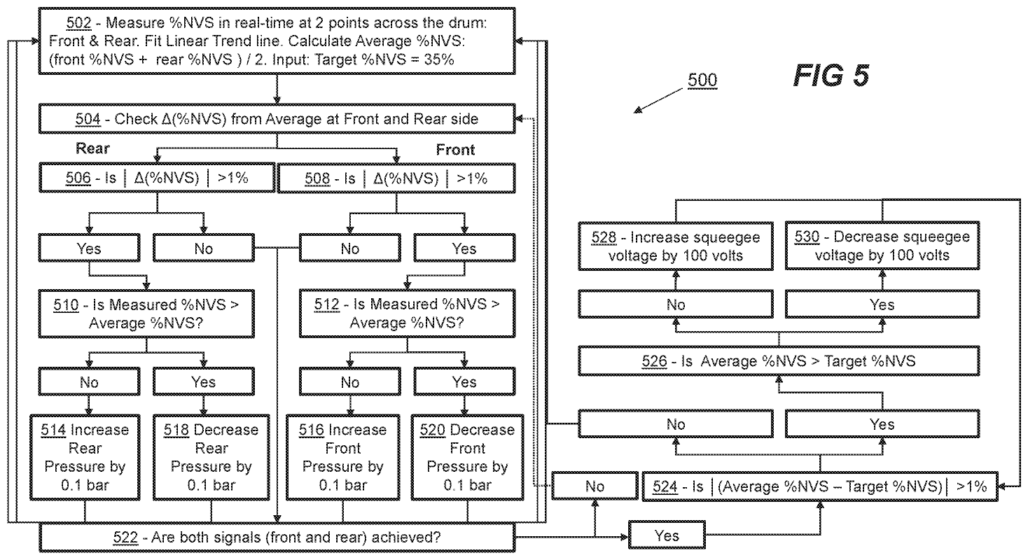

FIG. 5 shows a further example method 500 detailing actions that may be taken by the controller 140 in controlling the concentration of a printing substance. It should be understood that the controller may perform the actions described below in a different order to that shown in FIG. 5. The process may be a “closed loop” or continuous process, in which the controller 140 instructs and assesses measurements at predetermined, regular time intervals. At block 502, the controller 140 instructs at least two sensors 138 to take measurements at two separate points, such as a front side and a rear side, on the receiving member 102, in order to determine the concentration of non-volatile solids (% NVS) in the layer of printing substance across the surface of the receiving member 102. The controller 140 can fit a linear trend line to the measurements, as shown in FIGS. 2a-2c. An average % NVS can be calculated from the measurements taken, and a target, or desired, % NVS can be input into the controller to allow a comparison between the measured and target % NVS values.

At block 504, the difference between the measured and average % NVS values (Δ% NVS) at the front and rear side measurement points is assessed by the controller 140. At blocks 506 and 508, the controller 140 determines whether each difference, Δ% NVS, is greater than a predetermined error margin of, in this example, 1% NVS. If the controller determines that either difference is greater than 1% NVS, i.e. “Yes” to block 506 or 508, then the process continues to block 510 or 512, respectively. If the controller determines that either difference is less than 1% NVS, i.e. “No” to block 506 or 508, then the process continues to block 522, in which the controller determines whether both measurements are within the error margin set.

At blocks 510 and 512, the controller 140 determines, for each of the rear side and front side measurements, whether the measured % NVS is greater than the average % NVS. If it is not, the process continues to block 514 or 516, where the controller instructs the positioning system to increase the rear or front mechanical pressure, respectively, that is applied by one or more of the pressurizing rollers 126 by, for example, 0.1 bar. If the measured % NVS is greater than the average % NVS (“Yes” to block 510 or 512), the process continues to block 518 or 520, where the controller instructs the positioning system to decrease the rear or front mechanical pressure, respectively, applied by one or more of the pressurizing rollers 126 by, for example, 0.1 bar. The increase or decrease in pressure may be actioned by adjusting the positions of the first and second pneumatic components 128, which are positioned under the pressurizing rollers 126 at the front and rear of the apparatus 100.

Once mechanical pressure adjustments have been instructed at blocks 514-520, and in the case where the answer to block 522 is “No”, the process returns to block 502. If the answer to block 522 is “Yes”, the process proceeds to block 524, where the controller determines whether the difference between the average % NVS and the target % NVS is greater than the predetermined error margin of 1% NVS. If it is not, the process returns to block 502 (i.e, the process loop is closed and another set of measurements is taken); however, if the answer to block 524 is “Yes”, the process continues to block 526, where the controller 140 determines whether the average % NVS is greater than the target % NVS. If the average % NVS is not greater than the target % NVS (i.e. “No” to block 526, meaning that the average measured % NVS is outside the error margin and lower than the target % NVS), then the controller instructs, at block 528, an increase in the voltage applied to one or more of the pressurizing rollers 126 by its respective voltage source 130. If the average % NVS is greater than the target % NVS (i.e. “Yes” to block 526, meaning that the average measured % NVS is outside the error margin and higher than the target % NVS, as shown in the example of FIG. 2b), then the controller instructs, at block 530, a decrease in the voltage applied to one or more of the pressurizing rollers 126 by its respective voltage source 130. Once an appropriate adjustment has been made at block 528 or 530, the process returns to block 524, and is repeated until the difference between the average % NVS and the target % NVS is not greater than the predetermined error margin of 1% NVS (“No” at block 524), at which point the process returns to block 502.

While certain examples have been described above in relation to liquid electrophotographic printing, other examples can be applied to dry electrophotographic printing.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of controlling the concentration of a printing substance, the method comprising:
receiving a layer of printing substance on a printing substance receiving member;
measuring a parameter indicative of a current concentration of non-volatile material in the printing substance;
comparing the current concentration to a predetermined target concentration;
determining a concentration adjustment based on the comparison, the adjustment comprising at least one of:
(i) an adjustment to a pressure applied to the printing substance receiving member by a pressurizing member; and
(ii) an adjustment to a voltage applied to the pressurizing member;
and
controlling the concentration of the printing substance based on the determination.

2. The method of claim 1, wherein the printing substance transferred onto a surface of the printing substance receiving member comprises non-volatile material and a carrier fluid.

3. The method of claim 1, wherein controlling the concentration based on the determination comprises instructing a positioning system to adjust a position of the pressurizing member relative to the printing substance receiving member, to thereby adjust the mechanical pressure applied to the layer of printing substance by the pressurizing member.

4. The method of claim 1, wherein measuring a parameter indicative of a current concentration of non-volatile material in the printing substance comprises:
measuring a parameter indicative of a first current concentration at a first location on the printing substance receiving member; and
measuring a parameter indicative of a second current concentration at a second location on the printing substance receiving member, and
wherein the method includes:
comparing the first and second current concentrations to determine an adjustment to the pressure applied by the pressurizing member.

5. The method of claim 1, wherein controlling the concentration based on the determination comprises making a first adjustment to the concentration of the layer of printing substance, the method comprising:
measuring a parameter indicative of the adjusted concentration of non-volatile material in the printing substance;
comparing the adjusted concentration to the predetermined target concentration;
determining a second concentration adjustment based on the comparison, the second adjustment comprising at least one of:
(i) an adjustment to the pressure applied to the printing substance receiving member by the pressurizing member; and
(ii) an adjustment to the voltage applied to the pressurizing member;
and
controlling the concentration of the printing substance based on the determination of the second adjustment.

6. A concentration adjustment apparatus to cant ol the concentration of a printing substance, the apparatus comprising:
a printing substance receiving member;
at least one printing substance development unit to transfer a layer of printing substance onto a surface of the printing substance receiving member;
a sensor to measure a parameter indicative of a current concentration of non-volatile material in the printing substance on the surface of the printing substance receiving member;
a pressurizing member to apply pressure to the surface of the printing substance receiving member;
a voltage source to selectively apply a voltage to the pressurizing member; and
a cant roller to:
instruct the sensor to measure a parameter indicative of a current concentration of non-volatile material in the printing substance;
compare the current concentration to a predetermined target concentration; and
based on the comparison, control the concentration of the printing substance by instructing adjustment of at least one of:
(i) the pressure applied by the pressurizing member; and
(ii) the voltage applied to the pressurizing member.

7. The concentration adjustment apparatus of claim 6, wherein:
the printing substance development unit comprises a developer roller to transfer the layer of printing substance onto the surface of the printing substance receiving member;
the pressurizing member comprises a pressurizing roller to apply pressure to the transferred layer of printing substance; and
the developer roller and the pressurizing member are configured to move relative to the printing substance receiving member in order to transfer the layer of printing substance, and apply pressure, respectively, to the printing substance receiving member.

8. The concentration adjustment apparatus of claim 1, wherein the printing substance transferred onto a surface of the printing substance receiving member comprises non-volatile material and a carrier fluid.

9. The concentration adjustment apparatus of claim 6, wherein the apparatus comprises:
a positioning system to adjust a position of the pressurizing member relative to the printing substance receiving member, to thereby adjust the mechanical pressure applied to the layer of printing substance by the pressurizing member.

10. The concentration adjustment apparatus of claim 6, wherein the apparatus comprises:
a first sensor to measure a parameter indicative of a first current concentration of non-volatile material at a first location on the printing substance receiving member; and
a second sensor to measure a parameter indicative of a second current concentration of non-volatile material at a second location on the printing substance receiving member,
wherein the controller is provided to:
compare the first and second current concentrations;
determine an inclination of the pressurizing member relative to the surface of the printing substance receiving member; and
based on the determination, instruct the adjustment to the pressure applied the pressurizing member.

11. The concentration adjustment apparatus of claim 6, wherein the controller comprises a microprocessor and a memory.

12. The concentration adjustment apparatus of claim 11, comprising electronic circuitry to receive a control signal from the microprocessor and, in response, to cause the controller to adjust at least one of the pressure applied by the pressurizing member and the voltage applied to the pressurizing member.

13. The concentration adjustment apparatus of claim 6, wherein the apparatus comprises:
a first printing substance development unit to transfer a first layer of printing substance onto a surface of the printing substance receiving member;
an initial pressurizing member to apply pressure to the first layer of printing substance;
a second printing substance development unit to transfer a second layer of printing substance onto the first layer of printing substance on the printing substance receiving member;
at least one subsequent pressurizing member to apply pressure to the first and second layers of printing substance to generate a merged layer of printing substance; and
a printing substance removing member to remove the merged layer of printing substance from the printing substance receiving member.

14. A non-transitory computer readable storage medium comprising a set of computer-readable instructions stored thereon, which, when executed by a processor, cause the processor to, in a concentration adjustment apparatus:
instruct a sensor to measure a parameter indicative of a current concentration of non-volatile material in a printing substance on the surface of a printing substance receiving member;
compare the current concentration to a predetermined target concentration;
determine a concentration adjustment based on the comparison, the adjustment comprising at least one of:
(i) an adjustment to a pressure applied to the printing substance receiving member by a pressurizing member; and
(ii) an adjustment to a voltage applied to the pressurizing member;
and
instruct the adjustment of the concentration of the printing substance based on the determination.

15. The non-transitory computer readable storage medium of claim 14, wherein the processor is caused to, in comparing the current concentration to a predetermined target concentration, determine whether the current concentration is within a predetermined concentration error margin.
